(19) United States
(12) Patent Application Publication
(10) Pub. No.: US 2024/0166542 A1
(43) Pub. Date: May 23, 2024

(54) METHOD AND DEVICE FOR IN-SITU ENRICHING ANAMMOX BACTERIA BY CONVENTIONAL ACTIVATED SLUDGE

(71) Applicant: Beijing University of Technology, Beijing (CN)

(72) Inventors: Yongzhen PENG, Beijing (CN); Wanyi FENG, Beijing (CN); Jialin LI, Beijing (CN); Shenhua YANG, Beijing (CN); Shuai LI, Beijing (CN)

(73) Assignee: Beijing University of Technology, Beijing (CN)

(21) Appl. No.: 17/783,309

(22) PCT Filed: Oct. 29, 2021
(86) PCT No.: PCT/CN2021/127444

§ 371 Date: Jun. 8, 2022

(30) Foreign Application Priority Data
Apr. 8, 2021 (CN) 202110377669.2

(51) Int. Cl. C02F 3/30; C02F 3/00; C02F 3/20; C02F 101/10; C02F 101/16

(52) U.S. Cl. CPC C02F 3/307; C02F 3/006; C02F 3/20; C02F 3/303; C02F 2101/105; C02F 2101/166; C02F 2209/06; C02F 2209/22

(57) ABSTRACT

A method and device for in-situ enriching Anammox bacteria by conventional activated sludge, which belongs to a biological wastewater treatment technology. The device comprises a raw water tank, an anammox reactor and a water outlet tank. The method comprises the following steps: (1) taking traditional activated sludge from a municipal wastewater plant as inoculation sludge without special requirements on form of reactor and water quality of inflow; the mainstream anammox in-situ enrichment being realized mainly in three stages; (2) carbon and phosphorus removal stage, wherein carbon and phosphorus removal sludge is domesticated through joint control of aerobiotic time and sludge retention time; (3) partial nitrification stage, wherein the stage is realized through gradually extending the aerobiotic time; (4) anammox bacteria in-situ enrichment stage, wherein good culture retention conditions are provided through the artificial regulation strategies: (5) the method of the present invention only needs to construct or utilize the existing traditional activated sludge wastewater biological treatment devices and equipment without adding agents, which is conducive to the application of practical engineering.

### TECHNICAL FIELD

The present invention belongs to a technical field of wastewater biological treatment, and relates to a method and device for in-situ enriching Anammox bacteria by conventional activated sludge.

### BACKGROUND

The problem of water eutrophication of the water body is due to the unrestricted discharge of wastewater containing nitrogen element and phosphorus element, so that the algae in the receiving water body excessively multiply and the water quality is deteriorated. Natural water nitrogen element and phosphorus element, which increase the difficulty and the cost of water treatment. Therefore, the high efficiency of nitrogen and phosphorus removal of wastewater has attracted more and more attention. Anammox process is currently the most economical biological nitrogen removal process in the field of wastewater treatment, under anaerobic or anoxic conditions, which uses ammonia nitrogen (NH₄⁺—N) as an electron donor, uses nitrite nitrogen (NO₂⁻—N) as an electron acceptor and directly converts it into nitrogen (N₂), finally realizing the advantages of saving aeration energy consumption, saving carbon sources and reducing output of excess sludge, etc. The realization of anammox biological nitrogen removal in municipal wastewater treatment systems can greatly save energy consumption and is of great significance to biological nitrogen removal from wastewater. Mainstream anammox is to apply the anammox process in the mainstream of wastewater plants. The application of mainstream anammox process in municipal wastewater treatment with low C/N is currently one of the focus of global wastewater treatment research and development. If this process is widely used in municipal wastewater treatment and combined with resource recovery technology, simultaneous removal of organic carbon sources and nitrogen can be realized, and organic carbon sources can be recycled to the maximum. However, in terms of its current technological development, there are still some bottleneck problems to be solved, such as the problem of the source of NO₂⁻N; the growth and retention of anammox bacteria.

By strengthening the in-situ enrichment of anammox bacteria in the existing municipal wastewater treatment system and increasing the proportion of autotrophic nitrogen removal pathway of the system, the dependence of the traditional biological nitrogen removal process on the carbon to nitrogen ratio can be effectively reduced. It can effectively improve the effect of nitrogen removal and reduce the treatment cost. At present, the main bottleneck of in-situ enrichment of anammox bacteria in municipal wastewater comprises the following (1) there is no stable and continuous nitrous source, and nitrite oxidizing bacteria (NOB) and heterotrophic anammox bacteria compete for NO₂—N, which makes anammox bacteria at a disadvantage in the biological nitrogen removal system; (2) anammox bacteria have a long multiplication time, and due to water quality conditions of municipal wastewater of low temperature, low substrate, etc., anammox bacteria cannot be effectively in-situ concentrated and retained; (3) municipal wastewater inflow contains organic matter, and a higher organic matter concentration leads to the growth of heterotrophic bacteria, as a result, the sludge retention time of the biological treatment system is reduced, which is not conducive to the retention of anammox bacteria; the coexisting mixed system of carrier biofilm/granular sludge and flocculent sludge can balance the reinforcement of the mass transfer of gas, liquid and solid to give full play to their respective advantages, and make the biological treatment system more effective in removing pollutants. Therefore, it is the key to realize the anammox process of municipal wastewater by factitiously optimizing the regulation strategy to provide good culture enrichment and effective retention conditions for anammox bacteria.

### SUMMARY

The present invention strengthens the in-situ enrichment of anammox bacteria in municipal wastewater treatment plant through three stages: (1) inhibiting NOB at carbon and phosphorus removal stage: by joint control of aerobiotic time and sludge retention time, inhibition and elutriation of NOB are realized and the abundance and activity of NOB are reduced; (2) retaining ammonia oxidizing bacteria (AOB) at partial nitrification stage: by gradually extending the aerobiotic time, the activity of AOB is restored and the retention of AOB is realized to provide a stable NO₂⁻—N for the subsequent enrichment and culture of anammox bacteria; (3) making anammox bacteria growth and retention at anammox bacteria in-situ enrichment stage: good culture retention conditions are provided for in-situ enrichment of anammox bacteria through artificial regulation strategies: 1) adding a post-anoxic stage to provide sufficient anoxic time for the growth of anammox bacteria; 2) adding biological carrier/forming granular sludge to provide an attachment environment for anammox bacteria. After three stages of operation, the in-situ enrichment of anammox bacteria in the system is strengthened, and the proportion of autotrophic nitrogen removal pathway of the system in nitrogen removal pathways is increased, thereby treating municipal wastewater with mainstream anammox process is effectively realized, so as to economical and efficient nitrogen removal of municipal wastewater with low carbon to nitrogen ratio is realized. Meanwhile, the construction cost, treatment energy consumption and maintenance cost of the actual project can be saved. Therefore, the present invention has greater practical value and engineering significance.

A device for in-situ enriching Anammox bacteria by conventional activated sludge, comprises: a raw water tank (1), an anammox reactor (2), a water outlet tank (3) and an excess sludge tank (4), which are connected in sequence; wherein municipal wastewater enters the anammox reactor (2) from the raw water tank (1) via a water inlet (2.4) through a water inlet pump (2.2), and the anammox reactor (2) drains water with a drainage ratio of 30%-70% to the water outlet tank (3) via a water outlet (2.10);
the anammox reactor (2) is provided with a stirrer (2.5), a DO (Dissolved Oxygen) probe (2.7), a pH probe (2.8), and a DO/pH meter (2.9), the bottom of the anammox reactor (2) is provided with an aeration diffuser (2.6), and an aeration pump (2.1) is connected to the aeration diffuser (2.6), and an aeration rate is adjusted and controlled by a flowmeter (2.4).

A method of the above device comprises the following steps:
(1) carbon and phosphorus removal stage: each cycle of the anammox reactor (2) includes water feeding, anaerobic mixing, aeration mixing, settling, drainage and idleness, and the detailed steps are as follows:
i) taking a reflux sludge from a secondary sedimentation tank of a municipal wastewater treatment plant as inoculation sludge, and injecting the inoculation sludge into the anammox reactor (2), wherein sludge concentration is 3000 mg/L-5000 mg/L;
ii) taking municipal wastewater as a feed water, and making the anammox reactor (2) operate in anaerobic/aerobiotic mode, feeding the municipal wastewater from the raw water tank (1) into the anammox reactor (2) via the water inlet (2.4) through the water inlet pump (2.2); turning on the stirrer (2.5) to make the anaerobic mixing for 30-240 min after the water feeding; and at the aerobiotic aeration phase, turning on the aeration pump (2.1) and using the DO probe (2.7) of the DO/pH meter (2.9) for real-time online monitoring on DO to control DO in the system at 0.1-3.0 mg/L; iii) taking the pH probe (2.8) of the DO/pH meter (2.9) for real-time online monitoring on the change of pH in the system; when an inflection point of pH is detected in the anammox reactor (2), stopping the aeration pump (2.1) and determining an aeration time; after the aeration, turning off the aeration pump (2.1) and the stirrer (2.5) at the same time, and after the reaction, keeping static settling 20-120 min to separate sludge and water, and draining a supernatant to the water outlet tank (3) through a water outlet (2.10), then starting the idleness; wherein the anammox reactor (2) operates for 2-6 cycles per day; at the end of the aerobiotic phase of each cycle, an excess sludge is regularly discharged from the anammox reactor (2) to the excess sludge tank (4) through a sludge discharging outlet (2.11), and a sludge retention time is controlled for 5-30 days;
iv) achieving the carbon and phosphorus removal successfully when the outflow from anammox reactor (2) has a COD (Chemical Oxygen Demand) of less than 80 mg/L, COD removal rate of greater than 70%, NH₄⁺—N removal rate of less than 20%, and NO₂⁻—N concentration, nitrate nitrogen (NO₃⁻—N) concentration and total phosphorus (TP) concentration of less than 2 mg/L, respectively, for more than 10 days;
(2) partial nitrification stage: each cycle of the anammox reactor (2) includes water feeding, anaerobic mixing, aeration mixing, settling, drainage and idleness, and the detailed steps are as follows:
i) taking municipal wastewater as the feed water, and making the anammox reactor (2) operate in anaerobic/aerobiotic mode; feeding the municipal wastewater from the raw water tank (1) into the anammox reactor (2) via a water inlet (2.4) through a water inlet pump (2.2); turning on the stirrer (2.5) to make an anaerobic mixing for 30-240 min after the water feeding; and at aerobiotic aeration phase, turning on the aeration pump (2.1) and using the DO probe (2.7) of the DO/pH meter (2.9) for real-time online monitoring on DO to control DO in the system at 0.1-3.0 mg/L;
ii) extending the aeration time to 60-420 min; after the aeration, turning off the aeration pump (2.1) and the stirrer (2.5) at the same time, and after the reaction, keeping static settling for 30 min to separate sludge and water, and draining a supernatant to the water outlet tank (3) through the water outlet (2.10), then starting the idleness; wherein the anammox reactor (2) operates for 2-6 cycles per day; at the end of the aerobiotic phase of each cycle, the excess sludge is regularly discharged from the anammox reactor (2) to the excess sludge tank (4) through a sludge discharging outlet (2.11), and the sludge retention time is controlled for 5-30 days;
iii) achieving the partial nitrification successfully and then when the outflow from anammox reactor (2) has a COD of less than 120 mg/L, a COD removal rate of greater than 40%, a ratio of NH₄⁺—N concentration to NO₂⁻—N concentration of 1:1-1:1.6, and the NO₃⁻—N concentration and TP concentration of less than 2 mg/L, respectively, for more than 10 days;
(3) anammox bacteria in-situ enrichment stage: each cycle of the anammox reactor (2) includes water feeding, anaerobic mixing, aeration mixing, anoxic mixing, settling, drainage and idleness, and at this stage, a good carrier should be provided for in-situ enrichment of anammox bacteria by means of 1) forming granular sludge; 2) adding biological carrier; wherein the detailed steps of the forming granular sludge comprise:
i) taking municipal wastewater as a feed water, and making the anammox reactor (2) operate in anaerobic/aerobiotic/anoxic mode, feeding the municipal wastewater from the raw water tank (1) into the anammox reactor (2) via a water inlet (2.4) through a water inlet pump (2.2); turning on the stirrer (2.5) to make an anaerobic mixing for 30-240 min after the water feeding; and at the aerobiotic aeration phase, turning on the aeration pump (2.1) and using the DO probe (2.7) of the DO/pH meter (2.9) for real-time online monitoring on DO to control DO in the system at 0.1-3.0 mg/L;
ii) controlling the aeration time to 60-420 min, and turning off the aeration pump (2.1) after the aeration; controlling the time of the anoxic mixing for 30-260 min; stopping the stirrer (2.5) at the end of the reaction; shortening the time of settling to 2-20 min to separate the sludge and water, and draining a supernatant to the water outlet tank (3) through the water outlet (2.10), screening and returning the granular sludge with a particle size greater than 200 μm in the outflow to the anammox reactor (2) to avoid the loss of granular sludge, and then starting the idleness after the settling; wherein the anammox reactor (2) operates for 2-6 cycles per day; at the end of the aerobiotic phase of each cycle, the excess sludge is regularly discharged from the anammox reactor (2) to the excess sludge tank (4) through a sludge discharging outlet (2.12), and the sludge retention time is controlled for 5-30 days.

The adding biological carrier comprises:
i) stopping feeding water into the anammox reactor (2), and then adding polypropylene ethylene plastic carrier (2.12), and then restoring the water feeding, and the carrier accounts for ¼-½ of the volume of the anammox reactor (2); taking municipal wastewater as the feed water, and making the anammox reactor (2) operate in anaerobic/aerobiotic/anoxic mode; feeding the municipal wastewater from the municipal wastewater raw water tank (1) into the anammox reactor (2) via a water inlet (2.4) through a water inlet pump (2.2); turning on the stirrer (2.5) for anaerobic mixing for 30-240 min after the water feeding; at the aerobiotic aeration phase, turning on the aeration pump (2.1) and using the DO probe (2.7) of the DO/pH meter (2.9) for real-time online monitoring on DO to control DO in the system at 0.1-3.0 mg/L; and
ii) controlling the aeration time to 60-420 min, and turning off the aeration pump (2.1) after the aeration; controlling the mixing time of the anoxic mixing to 30-260 min; stopping the stirrer (2.5) at the end of the reaction; keeping static settling for 30 min to separate sludge and water, and draining a supernatant to the water outlet tank (3) through the water outlet (2.10), and then starting the idleness; wherein the anammox reactor (2) operates for 2-6 cycles per day; at the end of the aerobiotic phase of each cycle, the excess sludge is regularly discharged from the anammox reactor (2) to the excess sludge tank (4) through a sludge discharging outlet (2.11), and the sludge retention time is controlled for 5-30 days.

### BRIEF DESCRIPTION OF THE DRAWINGS

FIG. 1 is a device for in-situ enriching Anammox bacteria by conventional activated sludge (carbon and phosphorus removal stage, partial nitrification stage; and anammox bacteria in-situ enrichment stage);

In FIG. 1: 1—raw water tank; 2—anammox reactor; 2.1—aeration pump; 2.2—water inlet pump; 2.3—flowmeter; 2.4—water inlet; 2.5—stirrer; 2.6—aeration diffuser; 2.7—DO probe; 2.8—pH probe; 2.9—pH/DO meter; 2.10—water outlet; 2.11—sludge discharging outlet; 2.12—polypropylene ethylene plastic carrier; 3—water outlet tank; 4—excess sludge tank.

FIG. 2 is (a) an operation sequence diagram of carbon and phosphorus removal stage; (b) an operation sequence diagram of partial nitrification stage; and (c) an operation sequence diagram of anammox bacteria in-situ enrichment stage of the anammox reactor.

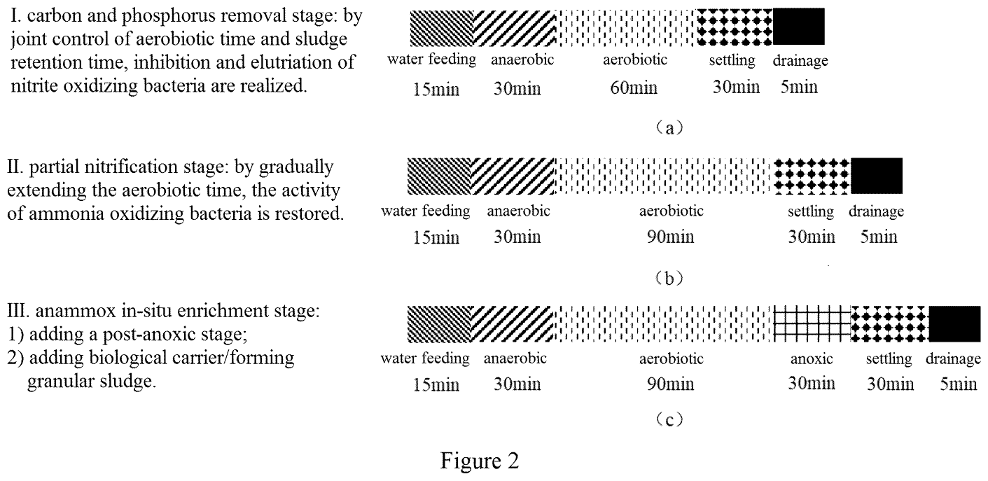

### DETAILED DESCRIPTION

The following describes the implementation of the present invention in detail with reference to the drawings and examples;

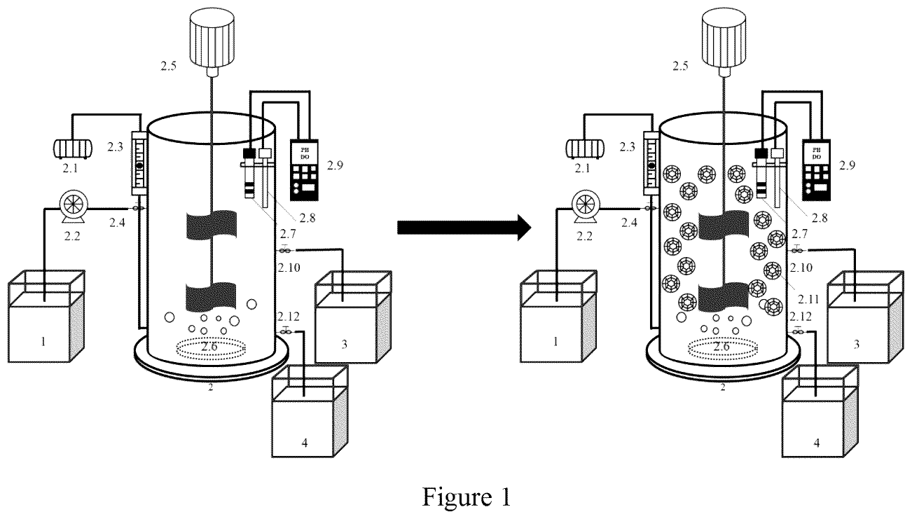

As shown in FIG. 1, a device for in-situ enriching Anammox bacteria by conventional activated sludge, comprises: a raw water tank (1), an anammox reactor (2), a water outlet tank (3) and an excess sludge tank (4), which are connected in sequence; wherein municipal wastewater enters the anammox reactor (2) from the raw water tank (1) via a water inlet (2.4) through a water inlet pump (2.2), and the anammox reactor (2) drains water with a drainage ratio of 30%-70% to the water outlet tank (3) via a water outlet (2.10);

the anammox reactor (2) is provided with a stirrer (2.5), a DO probe (2.7), a pH probe (2.8), and a DO/pH meter (2.9), the bottom of the anammox reactor (2) is provided with an aeration diffuser (2.6), and an aeration pump (2.1) is connected to the aeration diffuser (2.6), and an aeration rate is adjusted and controlled by a flowmeter (2.4);

A method and device for in-situ enriching Anammox bacteria by conventional activated sludge mainly comprises the following steps:
(1) carbon and phosphorus removal stage: each cycle of the anammox reactor (2) includes water feeding, anaerobic mixing, aeration mixing, settling, drainage and idleness, and the detailed steps are as follows:
i) taking a reflux sludge from a secondary sedimentation tank of a generic municipal wastewater treatment plant as inoculation sludge, and injecting the inoculation sludge into the anammox reactor (2), wherein sludge concentration is 3000 mg/L-5000 mg/L;
ii) taking municipal wastewater as a feed water, and making the anammox reactor (2) operate in anaerobic/aerobiotic mode, feeding the municipal wastewater from the raw water tank (1) into the anammox reactor (2) via the water inlet (2.4) through the water inlet pump (2.2); turning on the stirrer (2.5) to make the anaerobic mixing for 30-240 min after the water feeding; and at the aerobiotic aeration phase, turning on the aeration pump (2.1) and using the DO probe (2.7) of the DO/pH meter (2.9) for real-time online monitoring on DO to control DO in the system at 0.1-3.0 mg/L; iii) taking the pH probe (2.8) of the DO/pH meter (2.9) for real-time online monitoring on the change of pH in the system; when an inflection point of pH is detected in the anammox reactor (2), stopping the aeration pump (2.1) and determining an aeration time; after the aeration, turning off the aeration pump (2.1) and the stirrer (2.5) at the same time, and after the reaction, keeping static settling 20-120 min to separate sludge and water, and draining a supernatant to the water outlet tank (3) through a water outlet (2.10), then starting the idleness; wherein the anammox reactor (2) operates for 2-6 cycles per day; at the end of the aerobiotic phase of each cycle, an excess sludge is regularly discharged from the anammox reactor (2) to the excess sludge tank (4) through a sludge discharging outlet (2.11), and a sludge retention time is controlled for 5-30 days;
iv) achieving the carbon and phosphorus removal successfully when the outflow from anammox reactor (2) has a COD of less than 80 mg/L, a COD removal rate of greater than 70%, NH₄⁺—N removal rate of less than 20%, and NO₂⁻—N concentration, NO₃⁻—N concentration and TP concentration of less than 2 mg/L, respectively, for more than 10 days;
(2) partial nitrification stage: each cycle of the anammox reactor (2) includes water feeding, anaerobic mixing, aeration mixing, settling, drainage and idleness, and the detailed steps are as follows:
i) taking municipal wastewater as the feed water, and making the anammox reactor (2) operate in anaerobic/aerobiotic mode; feeding the municipal wastewater from the raw water tank (1) into the anammox reactor (2) via a water inlet (2.4) through a water inlet pump (2.2); turning on the stirrer (2.5) to make an anaerobic mixing for 30-240 min after the water feeding; and at aerobiotic aeration phase, turning on the aeration pump (2.1) and using the DO probe (2.7) of the DO/pH meter (2.9) for real-time online monitoring on DO to control DO in the system at 0.1-3.0 mg/L;
ii) extending the aeration time to 60-420 min; after the aeration, turning off the aeration pump (2.1) and the stirrer (2.5) at the same time, and after the reaction, keeping static settling for 30 min to separate sludge and water, and draining a supernatant to the water outlet tank (3) through the water outlet (2.10), then starting the idleness; wherein the anammox reactor (2) operates for 2-6 cycles per day; at the end of the aerobiotic phase of each cycle, the excess sludge is regularly discharged from the anammox reactor (2) to the excess sludge tank (4) through a sludge discharging outlet (2.11), and the sludge retention time is controlled for 5-30 days;
iii) achieving the partial nitrification successfully and then when the outflow from anammox reactor (2) has a COD of less than 120 mg/L, a COD removal rate of greater than 40%, a ratio of NH₄⁺—N concentration to NO₂⁻—N concentration of 1:1-1:1.6, and NO₃⁻—N concentration and TP concentration of less than 2 mg/L, respectively, for more than 10 days;
(3) anammox bacteria in-situ enrichment stage: each cycle of the anammox reactor (2) includes water feeding, anaerobic mixing, aeration mixing, anoxic mixing, settling, drainage and idleness, and at this stage, a good carrier should be provided for in-situ enrichment of anammox bacteria by means of 1) forming granular sludge; 2) adding biological carrier; wherein the detailed steps of the forming granular sludge comprise:
i) taking municipal wastewater as a feed water, and making the anammox reactor (2) operate in anaerobic/aerobiotic/anoxic mode, feeding the municipal wastewater from the raw water tank (1) into the anammox reactor (2) via a water inlet (2.4) through a water inlet pump (2.2); turning on the stirrer (2.5) to make an anaerobic mixing for 30-240 min after the water feeding; and at the aerobiotic aeration phase, turning on the aeration pump (2.1) and using the DO probe (2.7) of the DO/pH meter (2.9) for real-time online monitoring on DO to control DO in the system at 0.1-3.0 mg/L;
ii) controlling the aeration time to 60-420 min, and turning off the aeration pump (2.1) after the aeration; controlling the time of the anoxic mixing for 30-260 min; stopping the stirrer (2.5) at the end of the reaction; shortening the time of settling to 2-20 min to separate the sludge and water, and draining a supernatant to the water outlet tank (3) through the water outlet (2.10), and screening and returning the granular sludge with a particle size greater than 200 μm in the outflow to the anammox reactor (2) to avoid the loss of granular sludge, and then starting the idleness after the settling; wherein the anammox reactor (2) operates for 2-6 cycles per day; at the end of the aerobiotic phase of each cycle, the excess sludge is regularly discharged from the anammox reactor (2) to the excess sludge tank (4) through a sludge discharging outlet (2.12), and the sludge retention time is controlled for 5-30 days.

The adding biological carrier comprises:
i) stopping the feeding water into the anammox reactor (2), and then adding polypropylene ethylene plastic carrier (2.12), and then restoring the water feeding, and the carrier accounts for ¼-½ of the volume of the device; taking municipal wastewater as the feed water, and making the anammox reactor (2) operate in anaerobic/aerobiotic/anoxic mode; feeding the municipal wastewater from the municipal wastewater raw water tank (1) into the anammox reactor (2) via a water inlet (2.4) through a water inlet pump (2.2); turning on the stirrer (2.5) for anaerobic mixing for 30-240 min after the water feeding; at the aerobiotic aeration phase, turning on the aeration pump (2.1) and using the DO probe (2.7) of the DO/pH meter (2.9) for real-time online monitoring on DO to control DO in the system at 0.1-3.0 mg/L; and
ii) controlling the aeration time to 60-420 min, and turning off the aeration pump (2.1) after the aeration; controlling the mixing time of the anoxic mixing to 30-260 min; stopping the stirrer (2.5) at the end of the reaction; keeping static settling for 30 min to separate sludge and water, and draining a supernatant to the water outlet tank (3) through the water outlet (2.10), and then starting the idleness; wherein the anammox reactor (2) operates for 2-6 cycles per day; at the end of the aerobiotic phase of each cycle, the excess sludge is regularly discharged from the anammox reactor (2) to the excess sludge tank (4) through a sludge discharging outlet (2.11), and the sludge retention time is controlled for 5-30 days.
iii) taking domestic wastewater from a residential area in Beijing as the treating object to study the nitrogen and phosphorus removal performance of this system; when the system was operated for 80 days, the outflow reached national level A discharge standard.

| | COD | NH₄⁺—N | TN | TP |
|---|---|---|---|---|
| water quality | (mg/L) | (mg/L) | (mg/L) | (mg/L) |
| municipal wastewater | 250-1000 | 12-50 | 20-80 | 3.0-6.0 |
| water outflow | 35-45 | 3-5 | 8-10 | 0.2-0.5 |

1. A device for in-situ enriching Anammox bacteria by conventional activated sludge, comprising: a raw water tank, an anammox reactor, a water outlet tank and an excess sludge tank, which are connected in sequence;
wherein municipal wastewater enters the anammox reactor from the raw water tank via a water inlet through a water inlet pump, and the anammox reactor drains water with a drainage ratio of 30%-70% to the water outlet tank via a water outlet; and
the anammox reactor is provided with a stirrer, a DO probe, a pH probe, and a DO/pH meter, the bottom of the anammox reactor is provided with an aeration diffuser, and an aeration pump is connected to the aeration diffuser, and an aeration rate is adjusted and controlled by a flowmeter (2.3).

2. A method for applying the device according to claim 1, comprising the following steps:
(1) carbon and phosphorus removal stage: each cycle of the anammox reactor includes water feeding, anaerobic mixing, aerobiotic mixing, settling, drainage and idleness, and the detailed steps are as follows:
i) taking a reflux sludge from a secondary sedimentation tank of a municipal wastewater treatment plant as inoculation sludge, and injecting the inoculation sludge into the anammox reactor, wherein sludge concentration is 3000 mg/L-5000 mg/L;
ii) taking municipal wastewater as a feed water, and making the anammox reactor operate in anaerobic/aerobiotic mode, feeding the municipal wastewater from the raw water tank into the anammox reactor via the water inlet through the water inlet pump; turning on the stirrer to make the anaerobic mixing for 30-240 min after the water feeding; and at the aerobiotic phase, turning on the aeration pump and using the DO probe of the DO/pH meter for real-time online monitoring on DO to control DO in the anammox reactor at 0.1-3.0 mg/L;
iii) taking the pH probe of the DO/pH meter for real-time online monitoring on the change of pH in the system; when an inflection point of pH is detected in the anammox reactor, stopping the aeration pump and determining an aerobiotic time; after the aerobiotic phase, turning off the aeration pump and the stirrer at the same time, and after the reaction, keeping static settling 20-120 min to separate sludge and water, and draining a supernatant to the water outlet tank through a water outlet, then starting the idleness; wherein the anammox reactor operates for 2-6 cycles per day; at the end of the aerobiotic phase of each cycle, an excess sludge is regularly discharged from the anammox reactor to the excess sludge tank through a sludge discharging outlet, and a sludge retention time is controlled for 5-30 days;
iv) achieving the carbon and phosphorus removal successfully when the outflow from anammox reactor has a COD of less than 80 mg/L, a COD removal rate of greater than 70%, NH₄⁺—N removal rate of less than 20%, and NO₂⁻—N concentration, NO₃⁻—N concentration and TP concentration of less than 2 mg/L, respectively, for more than 10 days;
(2) partial nitrification stage: each cycle of the anammox reactor includes water feeding, anaerobic mixing, aerobiotic mixing, settling, drainage and idleness, and the detailed steps are as follows:
i) taking municipal wastewater as the feed water, and making the anammox reactor operate in anaerobic/aerobiotic mode; feeding the municipal wastewater from the raw water tank into the anammox reactor via a water inlet through a water inlet pump; turning on the stirrer to make an anaerobic mixing for 30-240 min after the water feeding; and at aerobiotic phase, turning on the aeration pump and using the DO probe of the DO/pH meter for real-time online monitoring on DO to control DO in the system at 0.1-3.0 mg/L;
ii) extending the aerobiotic time to 60-420 min; after the aerobiotic phase, turning off the aeration pump and the stirrer at the same time, and after the reaction, keeping static settling for 30 min to separate sludge and water, and draining a supernatant to the water outlet tank through the water outlet, then starting the idleness; wherein the anammox reactor operates for 2-6 cycles per day; at the end of the aerobiotic phase of each cycle, the excess sludge is regularly discharged from the anammox reactor to the excess sludge tank through a sludge discharging outlet, and the sludge retention time is controlled for 5-30 days;
iii) achieving the partial nitrification successfully and then when the outflow from anammox reactor has a COD of less than 120 mg/L, a COD removal rate of greater than 40%, a ratio of NH₄⁺—N concentration to NO₂⁻—N concentration of 1:1-1:1.6, and NO₃⁻—N concentration and TP concentration of less than 2 mg/L, respectively, for more than 10 days;
(3) anammox bacteria in-situ enrichment stage: each cycle of the anammox reactor includes water feeding, anaerobic mixing, aerobiotic mixing, anoxic mixing, settling, drainage and idleness, and at this stage, a carrier should be provided for in-situ enrichment of anammox bacteria by means of 1) forming granular sludge; 2) adding biological carrier; wherein the detailed steps of the forming granular sludge comprise:
i) taking municipal wastewater as a feed water, and making the anammox reactor operate in anaerobic/aerobiotic/anoxic mode, feeding the municipal wastewater from the raw water tank into the anammox reactor via a water inlet through a water inlet pump; turning on the stirrer to make an anaerobic mixing for 30-240 min after the water feeding; and at the aerobiotic phase, turning on the aeration pump and using the DO probe of the DO/pH meter for real-time online monitoring on DO to control DO in the system at 0.1-3.0 mg/L;
ii) controlling the aerobiotic time to 60-420 min, and turning off the aeration pump after the aerobiotic phase; controlling the time of the anoxic mixing for 30-260 min; stopping the stirrer at the end of the reaction; shortening the time of settling to 2-20 min to separate the sludge and water, and draining a supernatant to the water outlet tank through the water outlet, and screening and returning the granular sludge with a particle size greater than 200 μm in the outflow to the anammox reactor to avoid the loss of granular sludge, and then starting the idleness after the settling; wherein the anammox reactor operates for 2-6 cycles per day; at the end of the aerobiotic phase of each cycle, the excess sludge is regularly discharged from the anammox reactor to the excess sludge tank through a sludge discharging outlet, and the sludge retention time is controlled for 5-30 days;
the adding biological carrier comprising:
i) stopping the feeding water into the anammox reactor, and then adding polypropylene ethylene plastic carrier, and then restoring the water feeding, and the carrier accounts for ¼-½ of the volume of the anammox reactor; taking municipal wastewater as the feed water, and making the anammox reactor operate in anaerobic/aerobiotic/anoxic mode; feeding the municipal wastewater from the municipal wastewater raw water tank into the anammox reactor via a water inlet through a water inlet pump; turning on the stirrer for anaerobic mixing for 30-240 min after the water feeding; at the aerobiotic aeration phase, turning on the aeration pump and using the DO probe of the DO/pH meter for real-time online monitoring on DO to control DO in the system at 0.1-3.0 mg/L; and
ii) controlling the aerobiotic time to 60-420 min, and turning off the aeration pump after the aerobiotic phase; controlling the mixing time of the anoxic mixing to 30-260 min; stopping the stirrer at the end of the reaction; keeping static settling for 30 min to separate sludge and water, and draining a supernatant to the water outlet tank through the water outlet, and then starting the idleness; wherein the anammox reactor operates for 2-6 cycles per day; at the end of the aerobiotic phase of each cycle, the excess sludge is regularly discharged from the anammox reactor to the excess sludge tank through a sludge discharging outlet, and the sludge retention time is controlled for 5-30 days.
